(19) United States
(12) Patent Application Publication
(10) Pub. No.: US 2006/0026202 A1
(43) Pub. Date: Feb. 2, 2006

(54) Mobile resemblance estimation

(76) Inventors: Lars Isberg, Malmo (SE); Tord Olsson, Asmundtorp (SE); Hakan Rick, Loberod (SE); Markus Thornell, Malmo (SE)

Correspondence Address: BIRCH STEWART KOLASCH & BIRCH, PO BOX 747, FALLS CHURCH, VA, 22040-0747, US

(21) Appl. No.: 10/532,052

(22) PCT Filed: Oct. 22, 2003
(86) PCT No.: PCT/SE03/01634

§ 371 Date: Apr. 21, 2005

(30) Foreign Application Priority Data
Oct. 23, 2002 (SE) 0203132-6

(51) Int. Cl. G06F 17/30

(52) U.S. Cl. 707/104.1

(57) ABSTRACT

A method for estimating the resemblance of various objects comprises the step of recording (40) data of a real object using a communication device. Furthermore the following steps are included: transferring (41) said recorded data to a service server, extracting (42) a comparison object from said recorded data, making (43) a resemblance analysis between the comparison object and a previously stored object, and transferring (44) result data containing information about the resemblance analysis to a result unit.

### FIELD OF THE INVENTION

The present invention relates to a method for resemblance estimation, a server and a system for resemblance estimation and use of the method.

### BACKGROUND ART

Identifying and authenticating techniques are today used, inter alia, in various log-on processes which are required in order to get access to technical equipment or be admitted to locked premises.

A method for identification is described at the Internet address www.viisage.com/facexplore.htm and is based on a recorded image being matched against images which are stored in a database. The result of the matching can then be used in identification of people to give them access to computers or for authentication for e-commerce.

A drawback of the method, however, is that the technique is adapted to reliably prove that the person in the image is identical with the person in the item in the database. This places high demands on input data, which implies that the parameters for input data are relatively complex. For instance, input data is a video sequence where the system chooses parameters to ensure whether a recorded person represented by the parameters is identical with a person whose parameters are stored in a data-base.

An example of another method for voice identification is known from U.S. Pat. No. 6,411,926, which discloses a system where voice commands are recorded and sampled so as then to extract parameters from the digitised voice signal using a digital signal processor. These parameters are fed into a microprocessor which compares them with voice templates in a database. The digital signal processor is a “vocoder” (voice-operated coder). The technique tries to process the recorded voice to find out what it is saying. A difficulty in the technique is finding a voice template among a limited choice of adapted voice templates to control, for instance, menu handling in a mobile phone using voice commands.

A known method is available in the form of Internet-based services such as www.amialookalike.com, www.amiredneckornot.com or www.ratemybody.com. These services involve sending an image of a person, for instance of oneself, and then other users are to vote in order for the service to give a result. A drawback of the method is that for results, other users must participate and vote. Moreover it often takes a long time before voting is finished, or alternatively there is no deadline for voting, in which case a definite result fails to appear. The estimation of the result will also be highly dependent on who and how many people vote, which means that the quality of the result will not be very high. This makes the service less attractive. Sent in pictures must be published to other users, which may jeopardise the user's integrity.

### SUMMARY OF THE INVENTION

The object of the present invention is to provide a method for estimating the resemblance of a large group of users.

According to a first aspect, the invention relates to a method for estimating the resemblance of various objects, comprising the steps of recording data of a real object using a communication device, transferring said recorded data to a service server, extracting a comparison object from said recorded data, making a resemblance analysis between the comparison object and a previously stored object, and transferring result data containing information about the resemblance analysis to a result unit.

The method can be used in estimating how much a recorded object resembles a previously stored object. There may be a plurality of previously stored objects, and the resemblance analysis can be made on these previously stored objects. The real object can be, for example, an animal or a man. Using a communication device, it is possible to record data, such as sound, image or both. The communication device can be, for example, a computer which is connected via a computer network, such as the Internet, and which via the computer network can transfer information to a service server. The service server can be an ordinary PC (Personal Computer) which is connected to the computer network.

The step of transferring said recorded data may comprise the steps of transmitting said recorded data and receiving said recorded data in the service server.

The information about the resemblance analysis may comprise the degree of resemblance of the comparison object to a previously stored object. The resemblance can be stated as a value that may be within a range. The value can be defined so that the closer to the upper limit of the range the value is, the greater the degree of resemblance of the comparison object to the stored object. If the resemblance analysis is made on a plurality of stored objects, the object with the greatest resemblance can be selected. Result data may contain the stored object with the greatest resemblance and the value of the resemblance. Result data may also contain information about the stored object which the comparison object resembles most.

The result unit can be available in the service server. It can also be an external unit belonging to the owner of the service server. In this result unit, results from the resemblance analysis can be stored so as to be presented when required.

An advantage of the method according to the present invention is that specific software is not necessary in the communication unit, but currently available communication units can be used, which are capable of recording the data whose resemblance is to be estimated.

Another advantage is thus that it is easy for a user to use the method since he can use a communication device with which he is already familiar.

Yet another advantage of the method is that it allows a large number of new services which can be of public utility or of a more entertaining character.

Another advantage of the method is that it can be used by a large group of users. Each user can use his own communication device and transfer data to a common service server.

Yet another advantage of the method is that the resemblance analysis can be made automatically by software in the service server. This means that the resemblance analysis can provide an objective and reliable result.

In one embodiment of the method, the step of transferring said recorded data to a service server occurs at least partly wirelessly.

An advantage of this is that the communication device can be mobile. This means that the user can take the communication device along and activate the method when desired. It is, of course, necessary for him to have access to a mobile network where he is positioned.

The mobile communication device can be, for example, a mobile phone or a PDA (Personal Digital Assistant).

This can be advantageous for several occupational groups such as policemen, who can use the method at the scene of a crime for instance. A sound or image recording can be recorded and transmitted for estimation of the resemblance to previously stored sounds or images.

In another embodiment of the method, the step of transferring said recorded data to a service server comprises the steps of packaging said recorded data as a message, transferring the message and unpackaging the message in the service server.

The message can be, for example, an e-mail. The advantage of using a message is that this is a well-functioning way of transferring data. By using a message, a communication device or the service server need not be connected to the network all the time, but can be connected and receive the message when convenient.

One more advantage of using a message is that the method will be easy to implement since the intended users, who are ordinary people, will in future have mobile phones of their own which are connected to operators supporting message functions.

In another embodiment, the method further comprises the steps of transferring the identity of the communication device to the service server and storing the identity in the service server.

The identity of the communication device can be a phone number, e-mail address or IP (Internet Protocol) number. These steps are carried out for the service server at a later stage to be able to contact the communication device from which said recorded data came.

The identity can be stored temporarily or for a long time, depending on how the identity is to be used.

In one embodiment of the method, the result unit consists of the communication device.

This means that the user of the communication device can obtain information about the resemblance analysis he initiated. The user can obtain information about who in the object database the recorded object resembles most and how much the recorded object resembles this stored object.

An advantage of this method is that the user will obtain quick feedback on the resemblance analysis.

In one embodiment of the method, said result data contains an address link.

The link can be an address of an Internet page at which the user can find more information about, for instance, the resemblance analysis. Said result data may also contain a key which can be a password enabling the user to log on to his page with his personal settings, where his resemblance analyses are stored. If the user has a mobile phone, he can via WAP ((Wireless Application Protocol) connect to the page in question. The service server can be arranged with a WAP server so that the connection occurs directly to the service server.

In another embodiment of the method, said recorded data is a digital image.

The resemblance analysis can then be made, for instance, on a face using some type of face recognition program. It can also be used to determine the species of animals based on their appearance, or determine the breed of dogs.

In one embodiment of the method, said recorded data is a sound recording.

The resemblance analysis can then be made on a given voice to find a stored voice resembling the recorded voice. It may be a singing voice for instance. The resemblance analysis can also be made on a sound of an animal to determine the species of the animal.

In another embodiment of the method, said recorded data is a digital image and a sound recording.

The resemblance analysis is then made both on an image and on a sound, after which these two properties can be weighted together. An advantage of being able to use both image and sound is the possibility of a greater entirety in the resemblance estimation.

In another embodiment of the method, the service server comprises a number of stored objects, and the resemblance analysis comprises the step of identifying the stored object which most resembles the comparison object.

Determining which stored object most resembles the comparison object can be carried out, for instance, by calculating a value according to the degree of resemblance of the comparison object to a certain stored object. The higher the value, the greater the resemblance.

In one embodiment of the method, said result data contains the identified object which the comparison object resembles most, and a measure of the degree of resemblance.

The measure of the degree of resemblance can be a numerical value within a predetermined range. The measure can be defined so that the higher the value, the greater the resemblance of the comparison object to the identified object.

In one embodiment of the method, said result data contains additional information about the stored object which the comparison object resembles most.

This additional information can be facts about the stored object. If the stored object, for instance, represents a person, the additional information can be the name and telephone number of the person.

In another embodiment, the method comprises the step of storing the comparison object in the service server.

By storing the comparison object in the service server, the stored objects can be increased. The comparison object can then be used in future resemblance analyses.

In one embodiment of the method, the communication device is a mobile phone.

In another embodiment of the method, the message is an MMS (Multimedia Message Service) message.

If an address link is to be sent with result data, this address link can be attached to result data which in this case is an MMS.

In one embodiment, the method further comprises the steps of sending, in response to transferred data, a form to the communication device, recording form data using the communication device, transferring said recorded form data to the service server, the step of making the resemblance analysis comprises the step of using said form data in the resemblance analysis.

When the service server receives said recorded data, it transfers, in response, a form to the communication device. The form may comprise questions that are necessary to supplement the resemblance analysis. The use of the communication device can, for instance, enter the particulars that are demanded in the form. Form data may comprise the particulars that have been entered by the user and recorded by the communication device. Form data may be, for instance, the name, sex and age of the user. If the object database comprises many objects, the resemblance analysis can use form data to find the object which bears the greatest resemblance based on the data recorded in the first step as well as form data such as age. With form data the resemblance analysis can be made more relevant since the demanded object is defined more clearly and more distinctly.

According to a second aspect, the invention relates to a method for estimating the resemblance of various objects, comprising the steps of receiving data, extracting a comparison object from said data, making a resemblance analysis between the comparison object and a previously stored object, and transmitting result data containing information about the resemblance analysis.

In one embodiment of the method, the received data is an MMS message.

In another embodiment, the method comprises the steps of sending, in response to received data, a form, and receiving form data, the step of making the resemblance analysis comprising the step of using said form data in the resemblance analysis.

This method has essentially the same advantages as described above.

According to a third aspect, the invention relates to a server for estimating the resemblance of various objects, comprising a receiver which is adapted to receive data, an object database which is adapted to store an object, a service handler which is adapted to extract a comparison object, an object recogniser which is adapted to make a resemblance analysis between the comparison object and the stored object, and a transmitter which is adapted to transmit result data containing information about the resemblance analysis.

In one embodiment, the server comprises a factual database which is adapted to store information about the stored object.

In another embodiment, the server comprises a WAP server.

In one embodiment, the server comprises an SMS (Short Message Service) transmitter.

The SMS transmitter can be used to send an SMS message to an external unit. An SMS message may contain information about the address of the server so that the external unit can connect to the server at a later stage.

In one embodiment, the server comprises an i-mode server.

In one embodiment of the server, the receiver is an MMS receiver.

The server has essentially the same advantages as described above.

According to a fourth aspect, the invention relates to a system for estimating the resemblance of various objects, comprising a communication device which is adapted to record data of a real object and transfer said recorded data to a server which is arranged as claimed in any one of claims 20-23, via a network which at least partly is wireless.

The system has essentially the same advantages as described above.

According to a fifth aspect, the invention relates to use of the method as claimed in any one of claims 1-17 in a TV programme to make a resemblance analysis between a previously stored object and a large number of comparison objects which are extracted from received recorded data.

The method according to the present invention can be used, for instance, in competitions in a TV programme where the stored object in each part is a special celebrity and where the competition involves identifying the televiewer who participates in the competition and who most resembles the celebrity of this part. The televiewer participating in the competition can, for instance, use his own mobile phone to record an image of himself and then transmit the image to the service server of the TV programme for resemblance analysis.

### BRIEF DESCRIPTION OF THE DRAWINGS

The invention will now be described in more detail with reference to the accompanying schematic drawings, which by way of example illustrate different embodiments of the invention.

FIG. 1 is a schematic front view of a portable communication device.

FIG. 2 is schematic block diagram of some components of the portable communication device shown in FIG. 1.

FIG. 3 is a schematic block diagram of a server according to a first embodiment of the present invention.

FIG. 4 is a schematic block diagram of a server according to a second embodiment of the present invention.

FIG. 5 is a schematic block diagram of a server according to a third embodiment of the present invention.

FIG. 6 is a schematic block diagram of a system according to the present invention.

FIG. 7 is a flow chart of a general method according to the present invention.

FIG. 8 is a flow chart of a method in the mobile phone according to a first embodiment of the present invention.

FIG. 9 is a flow chart of a method in the server according to a first embodiment of the present invention.

### DESCRIPTION OF PREFERRED EMBODIMENTS

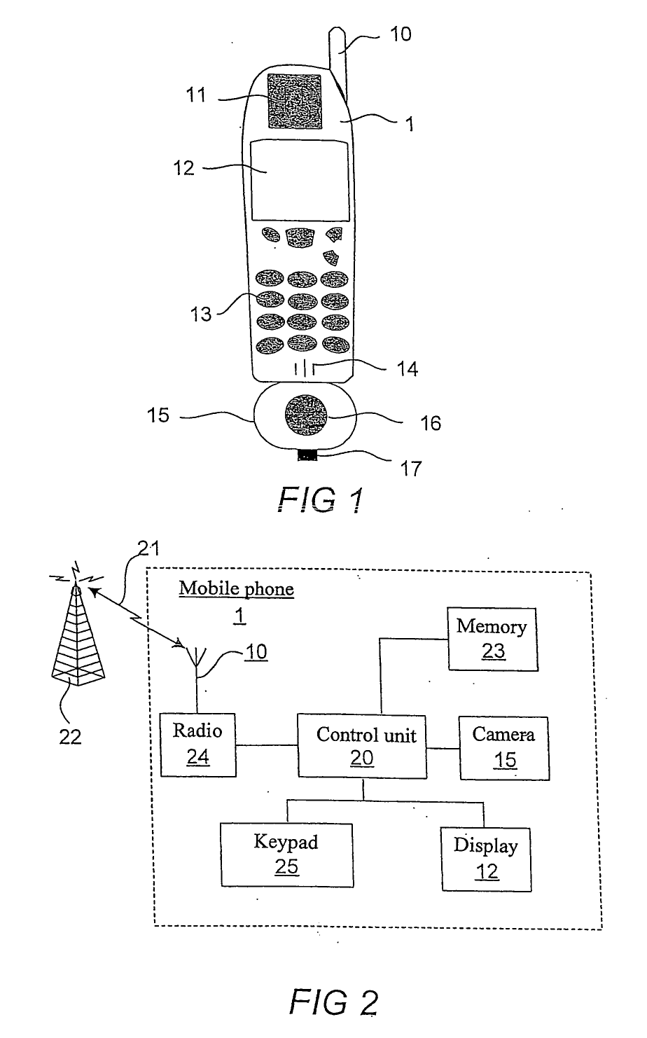

With reference to FIGS. 1-2, a portable communication device according to a first embodiment of the invention will be described in the following. The communication device is shown in FIG. 1 and is, in this embodiment, a mobile phone 1. The mobile phone 1 can be any available device for mobile telecommunication systems, such as GSM (Global Service for Mobile Transmission), CDMA (Code Division Multiple Access), UMTS (Universal Mobile Telecommunications System), PDC (Pacific Digital Cellular), AMPS (Advanced Mobile Phone System) or D-AMPS (Digital AMPS).

The mobile phone 1 comprises an aerial 10, a loud-speaker 11, a display 12, a plurality of keys 13, a microphone 14, a digital camera 15 with a lens 16 and a release 17. The digital camera 15 can be fully integrated into the mobile phone 1 or be detachable and, for use, be mounted on the mobile phone 1 by the user. The digital camera 15 can also be a separate unit which can transmit an image to the mobile phone 1 via a cable. Transmission can also occur wirelessly by, for example, Bluetooth or some other type of short distance radio communication, such as IR.

FIG. 2 shows some components of the mobile phone 1 in the context of the invention. A control unit 20 is responsible for the overall operation of the mobile phone 1 and is advantageously implemented with a commercially available microprocessor such as a CPU (Central Processing Unit), a DSP (Digital Signal Processor) or some other programmable logical unit.

The control unit is connected to a radio interface 10, 24 comprising an aerial 10 and a radio circuit 24. The radio interface 10, 24 is responsible for establishing and maintaining a wireless connection 21 to the base transceiver station 22. The radio circuit 24, which is well known to a person skilled in the art, comprises a series of analog and digital electronic components, which together constitute a radio receiver and radio transmitter. The radio circuit 24 comprises, for example, band-pass filter, amplifier, mixer, local oscillator, low-pass filter, AD converter etc.

The control unit 20 is also connected to an electric memory 23, such as a RAM memory, a ROM memory, an EEPROM memory, a flash memory, or a combination of these. The memory 23 is used for various tasks by the control unit 20, one of them being to store data and program instructions which constitute a man-machine interface, which comprises a keypad 25 and a display 12. The control unit 20 is further connected to the digital camera 15, by means of which a digital image can be recorded.

Service Server

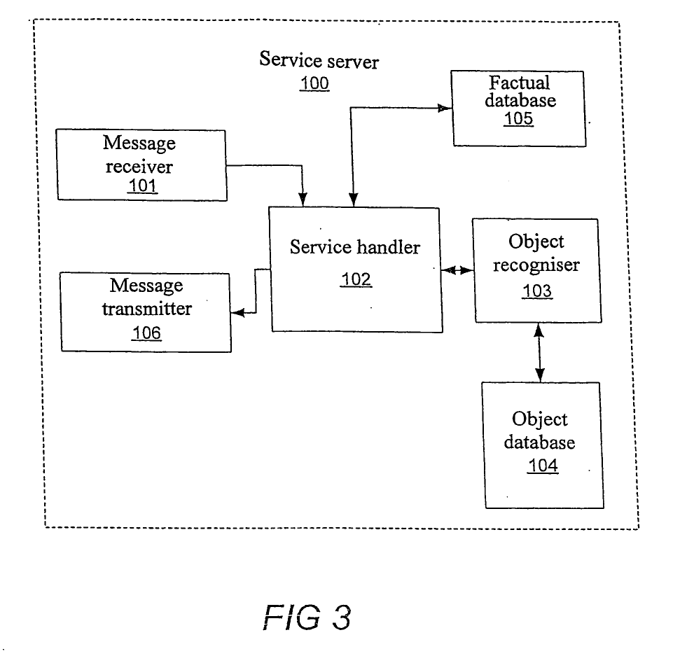

FIG. 3 is a block diagram of a service server 100 according to a first embodiment of the present invention. The service server 100 can be an ordinary PC. The service server 100 comprises a message receiver 101, a service handler 102, an object recogniser 103, an object database 104, a factual database 105 and a message transmitter 106.

The service handler 102 is responsible for the over-all operation of the service server 100 and is advantageously implemented with a commercially available micro-processor, such as a CPU (Central Processing Unit), or some other programmable logical unit. The object recogniser 103 can be implemented in the same unit as the service handler 102, and they can together constitute a control unit for the service server 100.

The object database 104 and the factual database 105 are implemented with a non-volatile memory, such as a hard disc.

The message receiver 101 and the message transmitter 106 constitute a radio interface.

The owner of the service server 100, which can be a service provider, can create an item in the object data-base 104 by entering, for instance, a portrait of a known person. The portrait is entered as an object which is described by a number of parameters. Moreover, a link to an item in the factual database 105 is created, in which data about the known person can be stored. This can be name, sex, age, length, weight, profession, hair colour, eye colour, description of the person, curriculum vitae etc. The information can be created as an XML document (extensible Markup Language) to make it easier to add facts.

The service server 100 codes received messages to a suitable format and stores the coded object temporarily.

General Method

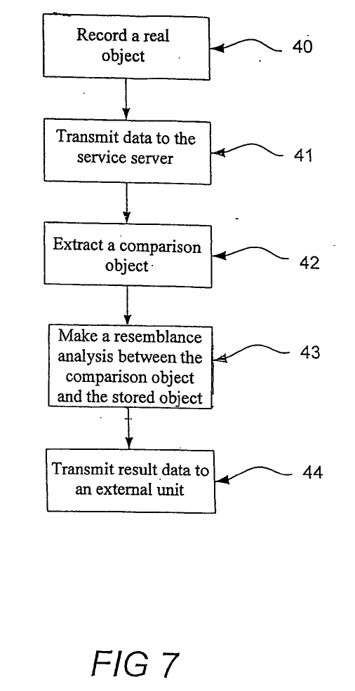

A method according to a first embodiment of the invention will now be explained in general with reference to the flow chart in FIG. 7.

The user records in step 40 data of a real object using the communication device 1. The communication device 1 transmits in step 41 recorded data to the service server 100. The service server 100 extracts in step 42 a comparison object from the recorded data. The comparison object is represented by a number of predetermined parameters which describe the recorded object. The service server 100 makes a resemblance analysis in step 43 and compares the comparison object with objects previously stored in the service server. The service server transmits in step 44 result data containing information about the resemblance analysis to a result unit 1; 100.

A Detailed Embodiment

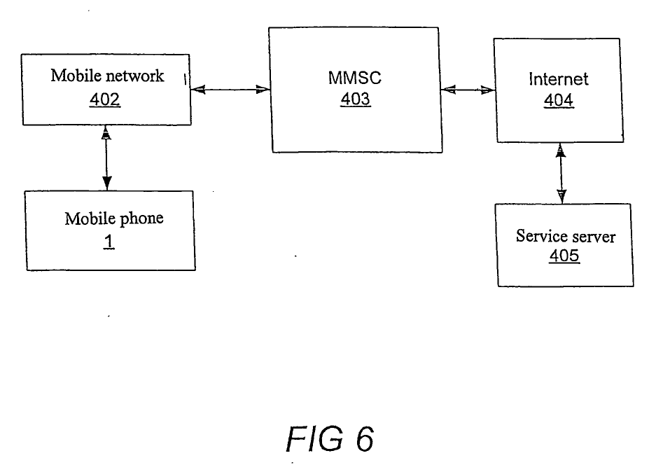

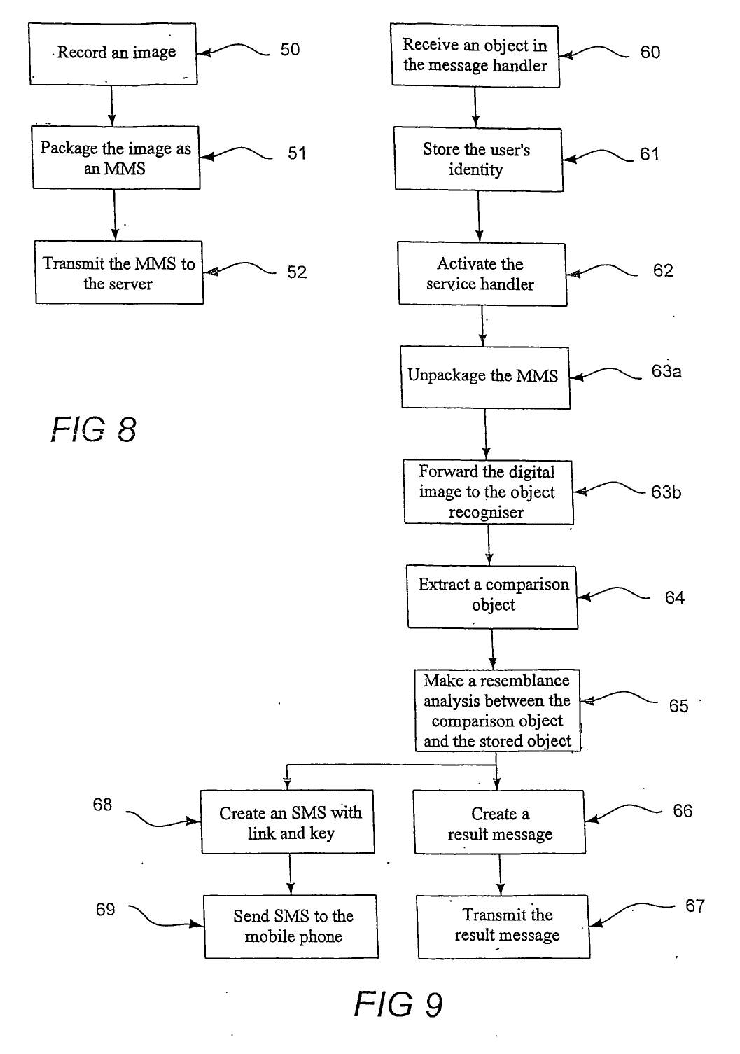

Next the method will be explained in more detail with reference to the block diagram in FIG. 6 and the flow charts in FIGS. 8 and 9.

The mobile phone 1 is arranged, when a user presses the release 17, to record in step 50 a digital image by means of the digital camera 15. In this embodiment, the user records a digital image of his face. The control unit 20 packages in step 51 the digital image as an MMS (Multimedia Message Service) message. The control unit 20 transmits in step 52 the MMS via the radio interface 10, 24 over a mobile network 402, to an MMSC (Multimedia Message Service Center) 403. The MMS message is sent on to the service server 100, 405 via the Internet 404. The MMS message can also be sent via a mobile network to the service server 100, 405. In step 60, the service server 100, 405 receives the MMS message via the Internet 404 by means of the message receiver 101 which is a software component. In step 61, the message receiver 101 stores the user's identity, such as phone number, e-mail address or IP number (Internet Protocol) temporarily in order to know the sender of the message.

In step 62, the message receiver 101 activates the service handler 102 and, in step 63a, unpackages the MMS to digital image format. In step 63b, the service handler 102 forwards the digital image to the object recogniser 103. In step 64, the object recogniser extracts from the digital image an object, which in this case describes the face of the user. An object is represented by a number of parameters which are selected so that the object will be described with sufficient accuracy. How accurately an object is to be described may be due to the requirements that are placed to ensure a correct comparison, which may be due to, for instance, the field of application.

In step 65, the object recogniser 103 makes a resemblance analysis by comparing the parameters which represent the received object with parameters which represent stored objects in the object database 104 to find the stored object which resembles the extracted object most. The stored objects describe different faces. Different parameters are weighted to different extents. In order to make the resemblance analysis, it is possible to use the face recognition such as “Eigenfaces”, which is also called PCA (Principle Component Analysis) and which is used by Viisage in their face recognition software, or “Local Feature Analysis” which is used by Indentix (previously Visionics) face recognition software, FaceIt, LFA. More information about the technology is to be found at the Internet address http://www.pcquest.com/content/depth/101100105.asp.

The factual database 104 contains additional information about the objects that are stored in the object database 104. This may involve, for instance, the name and age of the people whose faces are represented by the stored objects. In step 66, the service handler 102 creates a result message containing the best matching objects from the object database 104, information in a linked item in the factual database 105 regarding this object, and a measure of the degree of matching.

The result message may thus contain information that the user resembles Elvis Presley most, that he resembles him at a given value, for instance 79 of 100 possible, information about Elvis Presley and a portrait of Elvis. The value is calculated by comparing different parameters and weighting them in a suitable manner. It will then be possible to present the stored object which the received object resembles most by comparing the different values that have been calculated. The message transmitter 106 transmits, in step 67, the result message as an MMS message over the Internet 404 to MMSC 403. MMSC 403 forwards the MMS message over the mobile network 402. The mobile phone 1 receives the MMS message from the mobile network 402.

Alternative Embodiments

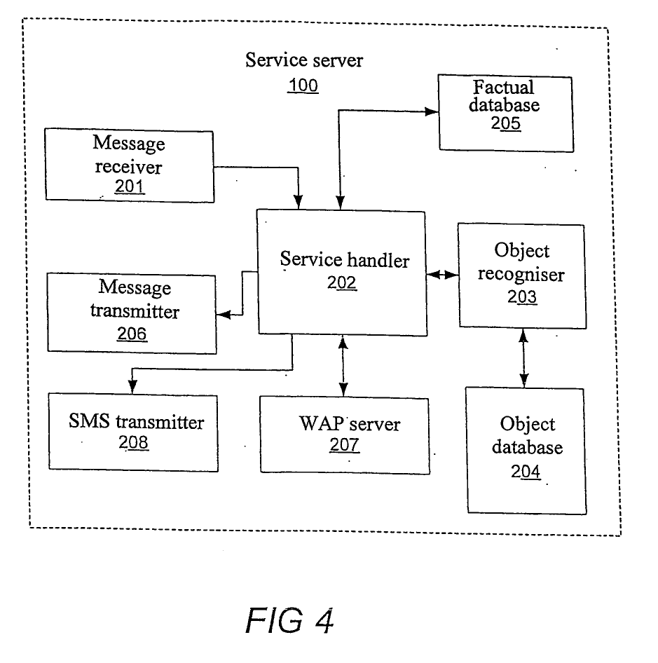

In another embodiment of the invention, which will be described with reference to FIG. 4 and FIG. 9, the service server 100 comprises a message receiver 201, a service handler 202, an object recogniser 203, an object database 204, a WAP (Wireless Application Protocol) server 207, a factual database 205, an SMS transmitter 208 and a message transmitter 206. The message receiver 201, the service handler 202, the object recogniser 203, the object database 204, the factual database 205 and the message transmitter 206 have the same function as corresponding components that have been described above in the first embodiment and FIG. 3. The method in the second embodiment is the same as has been described above in the first embodiment. Moreover the following steps take place in the second embodiment after making the resemblance analysis in step 65. In step 68, the service handler 202 creates an SMS containing a link and a key to the WAP server 207. In step 69, the SMS transmitter 208 sends this message to the mobile phone 1. The user can then contact the WAP server 207 on the link received and log on to a personal page using the key received. If the user contacts the WAP server 207, the service handler 202 handles a service where the user can supply more information and gain access to additional services in the service server 100. The service handler 202 stores the newly supplied information in the factual database 205 and the object database 204.

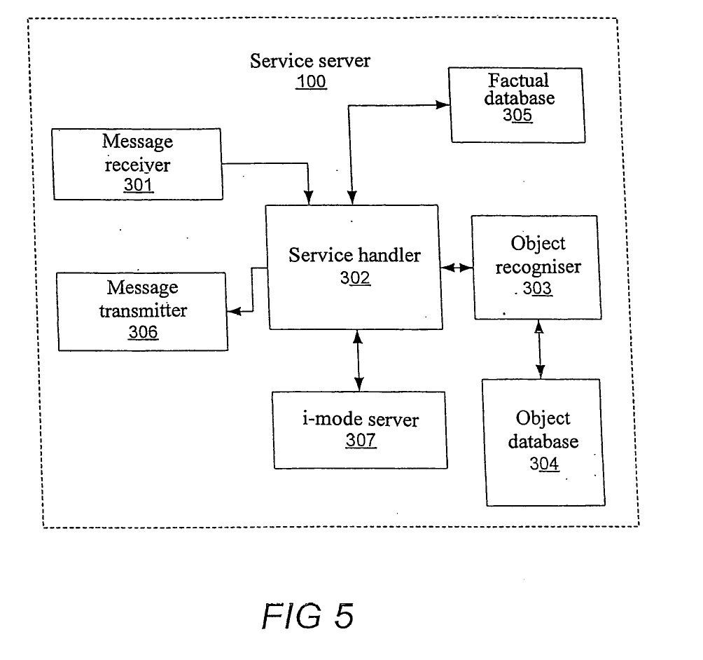

In a third embodiment of the invention, which will be described with reference to FIG. 5, the service server 100 comprises a message receiver 301, a service handler 302, an object recogniser 303, an object database 304, a factual database 305, a message transmitter 306 and an i-mode server 307. The message receiver 301, the service handler 302, the object recogniser 303, the object data-base . 304, the factual database 305 and the message transmitter 306 have the same function as corresponding components that have been described above in the first embodiment and FIG. 3. The method in the third embodiment is the same as has been described above in the first embodiment. The service handler 302 creates in step 66 an MMS message containing the found object from the object data-base 304, information from the factual database 305 and a link and a key to the i-mode server 307. In step 67, the message transmitter 306 transmits the MMS message to the mobile phone 1. The user of the mobile phone 1 can then contact the i-mode server 307. If the user contacts the i-mode server 307, the service handler 302 handles services where the user may supply more information and gain access to additional services. The service handler 302 stores newly supplied information in the factual database 305 and the object database 304.

If the user receives a link and a key to the WAP server 207 or the i-mode server 307, he may, for instance, register for a competition about who resembles Elvis Presley most. A further conceivable application is that this competition is presented in the form of a TV programme or as some other public event.

Sound Object

If the object is a sound, it may, for instance, be a voice sample of a person where the person's voice is compared by the object recogniser 103, 203, 303 with the voice samples that are stored in the object database 104, 204, 304, which then constitute a voice database. A voice may for instance be recorded by the microphone 14 of the mobile phone 1. The object recogniser 103, 203, 303 finds that voice in the voice database, which may consist of, for example, voices of known people, which resembles the received voice sample most. The resemblance analysis can be made by a frequency analysis of the voice, for instance. The object recogniser 103, 203, 303 feeds the hit result in the form of the voice sample from the voice database with its identity to the service handler 102, 202, 302 together with an estimated measure of the degree of matching in the hit. The service handler 102, 202, 302 then creates a message with the voice sample, the degree of hitting and information about the person whose voice sample was found, which it collects from the factual database 105, 205, 305. For instance, the message may contain information that the user sounds most like Elvis Presley, does so at the value 68 of 100, and personal information about Elvis Presley and also a voice sample of Elvis. The user also receives a link and a key to additional services on the WAP server 207 or i-mode server 307 of the service vendor, and may there, for example, register for a competition about who sounds most like Elvis Presley. A further conceivable application is that this competition is presented in the form of a radio programme.

Other examples of sound objects are twitterings of birds, in which case one gets to know the species from which the twittering originates, together with facts from the factual database about species-typical properties, and a sound sample of a bird of the species in question. This is also applicable to sounds of engines or musical instruments.

Alternatively, the user may produce a sound object by making, for instance, a sound recording of the sound of a bird, using a mobile phone. This object is sent by an MMS message to the service server which makes a resemblance analysis on the sound object. The MMS message may also contain text entered by the user and intended for additional control of the service. This can be information about the selected service variant, location and time.

Image Object and Sound Object

If the object is an image as well as a sound recording, it may, for instance, constitute a portrait of a person, the appearance of the person being compared, by means of the object recogniser 103, 203, 303, with the portraits that are stored in the object database 104, 204, 304 and constitute a voice sample of a person, where the voice of the person is compared by means of the object recogniser 103, 203, 303 with the voice samples that are stored in the object database 104, 204, 304. In this case, the object database 104, 204, 304 contains both voice samples and portraits. The object recogniser 103, 203, 303 finds that portrait in the object base 104, 204, 304, which may consist of, for instance, portraits of known people, which resembles the received portrait most, and finds that voice in the voice data-base, which may consist of, for instance, voices of known people, which resembles the received voice sample most. The object recogniser 103, 203, 303 feeds the hit result in the form of the portrait and the voice sample from the object database 104, 204, 304 with its identities to the service handler 102, 202, 302 together with an estimated measure indicating the degree of matching of the hit. The service handler 102, 202, 302 then creates a message with the portrait, the voice sample, the hitting degree and information about the people in the portrait and the voice sample, respectively, which it collects from the factual database 105, 205, 305. For instance, the result data can be that the user resembles Elvis Presley most, does so at the value 82 of 100, information about Elvis Presley and his portrait and that the user sounds like Bruce Springsteen and does so at the value of 88 of 100 and receives information about Bruce Springsteen and a voice sample of him. Alternatively, the user will also get to know that he sounded like Elvis at the value 18 of 100 and resembled Bruce at the value 22 of 100. Another alternative is that voice and appearance are weighted to a combined resemblance value, and in the Example above, the user gets to know that in respect of voice and appearance he resembles Johnny Cash most, does so at the value 73 of 100, and receives information about Johnny Cash, his portrait and a voice sample of him.

The user also receives a link and a key to additional services on the WAP server 207 or the i-mode server 307 of the service vendor, and may there, for instance, register for a competition about who resembles Johnny Cash most in respect of voice and appearance. A further conceivable application is that this competition is presented in the form of a TV programme or some other public event.

The owner of the service server 100 can alternatively create an item in the object database 104, 204, 304 by entering, for instance, a characteristic sound of the engine of a motorcycle model. Moreover, a link is created to an item in the factual database 105, 205, 305, where the service provider enters data about the motorcycle model. This may involve manufacturer, name of the model, year of construction, performance, general agent etc. The information can be created as an XML document (extensible Markup Language) so that it will be easier to add facts.

Modifications

It will be appreciated that many modifications of the above-described embodiments of the invention are feasible within the scope of the invention, which is defined in the appended claims.

Other examples of image objects are dogs about which one gets to know the breed, along with facts about breed-specific properties and breeder, and also an image of a dog of the breed in question. This is also applicable to mushrooms, flowers, leaves or vehicles.

For instance, the communication device, which in the Examples above is a mobile phone, can be a PDA or some other similar device with the necessary functions for recording data and transmitting as well as receiving data.

The message receiver 101, 201, 301 can handle one or more message formats. Examples of such formats are EMS (Enhanced Message Service), MMS and e-mail.

The object can be an image, a sound or be a multi-media object including sound and image. The user may have the option of adding text for additional control of the method. This can be information about the selected service variant, i.e. whether it is an image or a sound that is to be compared, age, sex and personal data.

The object database 104, 204, 304 and the factual database 106, 206, 306 can be updated automatically by the users' transmitted objects and facts being added continuously. It is convenient to request the user's consent thereto. The consent is suitably provided by the user using the link and the key that can be attached to the result message to contact the service provider's WAP server 207 or i-mode server 307 and there give his consent via a safe connection. Alternatively, the user is contacted about the option via a separate SMS about this or via WAP push, so as to prevent violation of national laws about storing information about individuals.

The method can also be used to allow a first user of a mobile communication device to find a lookalike. The first user can then transmit an image of himself that is stored in the service server. If/when a second user who resembles the first user transmits an image of himself to the service server, the service server can be arranged so that both receive information in their mobile phones that a lookalike has been found.

If the method is used, for instance, in a competition, in which the person is to be found who most resembles a given celebrity, the user may not to get to know whether he resembles anyone in a first stage, and only later gets to know that he has won the competition and how much he resembles a celebrity.

It is also possible to record an image of a face using a digital camera, transmit the image to a PC which is connected to a network, such as the Internet, transmit the image to the service server 100, which makes the resemblance analysis and transmits the result of the resemblance analysis back to the PC. In this case, the digital camera and the PC constitute a communication device. The digital camera can be integrated into the PC.

It is also possible to use encryption software and encrypt the recorded object before transmitting it.

A recorded object can be a fingerprint. The resemblance analysis is then made using suitable software for fingerprint recognition.

With reference to the first detailed embodiment and the block diagram in FIG. 6 and also the flow charts in FIGS. 8 and 9, an additional step can be introduced. After the service server 100 has received an object in step 60, the service server 100 can be arranged to send a WAP push to the mobile phone. The WAP push can send a form or a reference to a form using, for instance, an MMS, which the user of the mobile phone 1 fills in and sends back to the service server 100 as an MMS. If the method is used in dating service, the form may comprise, for instance, information about name, sex, length, interests etc. When the service server 100 receives the form, the service server 100 makes the resemblance analysis based on the received recorded information and the information received in the form.

1. A method for estimating the resemblance of various objects, comprising the steps of
recording (40; 50) data of a real object, which is a face, using a communication device (1),
transferring (41; 52, 60) said recorded data to a service server (100; 405),
extracting (42; 64) a comparison object from said recorded data,
making (45; 65) a resemblance analysis between the comparison object and a previously stored object, and
transferring (44; 67) result data containing information about the resemblance analysis to a result unit ( i; 100; 405):

2. A method as claimed in claim 1, wherein the step of transferring (41; 52, 60) said recorded data to a service server (100; 405) at least partly occurs wirelessly.

3. A method as claimed in claim 1, wherein the step of transferring (41; 52, 60) said recorded data to a service server (100; 405) comprises the steps of packaging (51) said recorded data as a message, transferring the message to a service server, and unpackaging (63a) the message in the service server.

4. A method as claimed in claim 1, further comprising the steps of transferring (41) the identity of the communication device (1) to the service server (100; 405) and storing (61) the identity in the service server.

5. A method as claimed in claim 1, wherein the result unit consists of the communication device (1).

6. A method as claimed in claim 1, wherein said result data contains an address link.

7. A method as claimed in claim 1, wherein said recorded data is a digital image.

8. A method as claimed in claim 1, wherein the service server (100; 405) comprises a number of stored objects and the resemblance analysis comprises the step of
identifying the stored object which the comparison object resembles most.

9. A method as claimed in claim 8, wherein said result data contains the identified object which the comparison object resembles most and a measure of the degree of resemblance.

10. A method as claimed in claim 9, wherein said result data further contains additional information about the stored object which the comparison object resembles most.

11. A method as claimed in claim 1, further comprising the step of storing the comparison object in the service server (100; 405).

12. A method as claimed in claim 1, wherein the communication device is a mobile phone.

13. A method as claimed in claim 3, wherein the message is an MMS (Multimedia Message Service) message.

14. A method as claimed in claim 1, further comprising the steps of
sending, in response to transferred data, a form to the communication device (1),
recording form data using the communication device (1),
transferring said recorded form data to the service server, the step of making (45; 65) the resemblance analysis comprising the step of using said form data in the resemblance analysis.

15. A method for estimating the resemblance of various objects, comprising the steps of
receiving (60) recorded data of a real object, which is a face,
extracting (42; 64) a comparison object from said data,
making (45; 65) a resemblance analysis between the comparison object and a previously stored object, and
transmitting (44; 67) result data containing information about the resemblance analysis.

16. A method as claimed in claim 15, wherein said received data is an MMS message.

17. A method as claimed in claim 15, further comprising the steps of
sending a form in response to received data, and
receiving form data, the step of making (45; 65) the resemblance analysis comprising the step of using said form data in the resemblance analysis.

18. A method as claimed in claim 15, further comprising the step of identifying the stored object which the comparison object resembles most,
said result data containing the identified object which the comparison object resembles most and a measure of the degree of resemblance.

19. A method as claimed in 15, further comprising the step of storing the comparison object in the service server (100; 405).

20. A server (100; 405) for estimating the resemblance of various objects, comprising a receiver (101; 201; 301) which is adapted to receive recorded data of a real object, which is a face, an object database (104; 204; 304) which is adapted to store an object, a service handler (102; 202; 302) which adapted to extract a comparison object, an object recogniser (103; 203; 303) which is adapted to make a resemblance analysis between the comparison object and the stored object, and a transmitter (106; 206; 306) which is adapted to transmit result data containing information about the resemblance analysis.

21. A server (100; 405) as claimed in claim 20, further comprising a factual database (105, 205, 305) which is adapted to store information about the stored object.

22. A server (100; 405) as claimed in claim 20, further comprising a WAP server.

23. A server (100; 405) as claimed in claim 20, further comprising an SMS transmitter.

24. A server (100; 405) as claimed in claim 20, further comprising an i-mode server.

25. A server (100; 405) as claimed in claim 20, wherein the receiver (101; 201; 301) is an MMS receiver.

26. A server (100; 405) as claimed in claim 20, further adapted to identify the stored object which the comparison object resembles most,
said result data containing the identified object which the comparison object resembles most and a measure of the degree of resemblance.

27. A server (100; 405) as claimed in claim 20, further adapted to store the comparison object.

28. A server (100; 405) as claimed in claim 20, further adapted to send, in response to said received data, a form, and adapted to receive form data, the server being adapted to use said form data in the resemblance analysis.

29. A system for estimating the resemblance of various objects, comprising a communication device (1) which is adapted to record data of a real object and transfer said recorded data to a server (100; 405) which is arranged as claimed in claim 20, via a network which at least partly is wireless.

30. Use of the method as claimed in claim 1 in a TV programme to make a resemblance analysis between a previously stored object and a large number of comparison objects which are extracted from received recorded data.
